(19) United States
(12) Patent Application Publication
(10) Pub. No.: US 2024/0211241 A1
(43) Pub. Date: Jun. 27, 2024

(54) METHOD FOR CARRYING OUT A DECISION FOR UPGRADING AND/OR DEPLOYING SOFTWARE ON MULTIPLE HETEROGENOUS DEVICES

(71) Applicants: Robert Bosch GmbH, Stuttgart (DE); Carnegie Mellon University, Pittsburgh, PA (US)

(72) Inventors: Arne Hamann, Ludwigsburg (DE); Dakshina Narahari Dasari, Renningen (DE); Dirk Ziegenbein, Freiberg Am Neckar (DE); Michael Pressler, Karlsruhe (DE); Tianshu Huang, Pittsburgh, PA (US)

(21) Appl. No.: 18/530,591

(22) Filed: Dec. 6, 2023

(30) Foreign Application Priority Data
Dec. 23, 2022 (DE) 10 2022 214 373.6

(51) Int. Cl. G06F 8/65

(52) U.S. Cl. CPC G06F 8/65

(57) ABSTRACT

A method for carrying out a decision for upgrading and/or deploying software on multiple heterogenous devices. The method includes: receiving a request to upgrade and/or deploy software on at least one of the devices; initiating a connection to the at least one of the devices; initiating a process for determining at least one capability of the at least one connected device for executing the software, the initiating being carried out via the connection, the process being initiated for being executed by the at least one connected device; receiving a result of the initiated process; and carrying out the decision for the upgrade and/or deployment of the software based on the received result.

### CROSS REFERENCE

The present application claims the benefit under 35 U.S.C. § 119 of German Patent Application No. DE 10 2022 214 373.6 filed on Dec. 23, 2022, which is expressly incorporated herein by reference in its entirety.

### FIELD

The present invention relates to a method for carrying out a decision for upgrading and/or deploying software on multiple heterogenous devices. Furthermore, the present invention relates to a data processing apparatus, a device as well as a computer program.

### BACKGROUND INFORMATION

In Edge Computing, the edge typically refers to a location closer to the user and/or application (in the sense of closer within an organization or closer to where data is generated) and hosts multiple compute nodes capable of executing applications and/or containers. Users then connect to the edge interface and deploy their application or container onto the edge. A dedicated edge orchestrator may map the incoming application or application container on a suitable node.

One of the key problems in these edge orchestration scenarios is orchestrating and deploying software across these heterogeneous nodes. Deploying software with Quality of Service (Qos) requirements on heterogenous hardware nodes with different computation capabilities is challenging and time consuming.

### SUMMARY

According to aspects of the present invention, a method, a data processing apparatus, a device, and a computer program, are provided. Features and details of the present invention are disclosed herein. Features and details of the present invention disclosed in the context to the method also correspond to the apparatus, the device as well as the computer program, and vice versa in each case.

According to an aspect of the present invention, a method for carrying out a decision for upgrading and/or deploying software on multiple heterogenous devices is provided. The multiple heterogeneous devices may, e.g., be multiple compute nodes used for edge computing or other computing devices with different computing capabilities. The devices may be capable of executing the software like applications and/or application containers. The software may be written in an intermediate byte code format like WebAssembly.

According to an example embodiment of the present invention, the method may comprise receiving a request to upgrade and/or deploy software on at least one of the devices. In the example of edge computing, a user may connect to an edge interface and initiate the deployment of the software, particularly the application or application container, onto the edge. An orchestrator, particularly a dedicated edge orchestrator, may then receive the request according to the method.

Furthermore, according to an example embodiment of the present invention, the method may comprise initiating a connection to the at least one of the devices. The connection may be a data connection or the like, particularly using a network like a mobile communication network and/or internet. Additionally, the method may comprise initiating a process for determining at least one capability of the at least one connected device for executing the software, particularly via the connection. In the example of edge computing, this is particularly because the orchestrator is used to map the incoming application or application container on a most suitable node. The most suitable node may therefore be determined by the initiated process. Particularly, the software to be upgraded and/or deployed has Quality of Service (QOS) requirements that are considered by the process.

Also, according to an example embodiment of the present invention, the process may be initiated for being executed at least partially or fully by or on the at least one connected device. In other words, the process, e.g. at least one benchmark, is not carried out by the orchestrator directly but initiated to be carried out decentralized by the at least one device.

Then, according to an example embodiment of the present invention, the method may also comprise receiving a result of the initiated process, particularly via the connection. The received result may comprise at least one benchmark result and/or a quantification of the at least one capability.

The initiation of the process and receiving of the result allows carrying out a decision for the upgrade and/or deployment of the software based on the received result, particular in order to upgrade and/or deploy the software onto the most suitable device for the execution of the software according to the received result and/or only, if the device is capable of executing the upgraded software. The present invention may therefore provide a mechanism that automatically quantifies the capability like a computational capability of a device like a node in a system of devices with different capabilities and to map the software to be upgraded and/or deployed on the device providing the right computation capabilities.

The provided method according to the present invention may also allow for the software to specify more detailed requirements regarding the target platform using the request and to enable an orchestration algorithm for a more suitable deployment, especially when dealing with heterogeneous nodes that dynamically enter and leave the system.

The provided method of the present invention may also provide the use of benchmarks according to the initiated process which are compiled to an intermediate bytecode format like WebAssembly which can be executed on any device or node with a supporting runtime, irrespective of the architecture.

The deploying may also be referred to as mapping the software, particularly applications and/or application containers, on the devices in the form of nodes of a computational system. According to an example embodiment of the present invention, the devices may be configured as nodes, which may enter and exit the computing system dynamically. A centralized orchestrator may be used to carry out the steps of the method, particularly to deploys the software to different nodes. On the devices, a local coordinator may be used to communicate with the centralized orchestrator via the connection and to carry out the initiated process. For the initiating the process, the orchestrator may send a set of benchmarks to derive the result, particularly the capabilities of the device where the benchmarks are carried out.

The decision may comprise an upgrade and/or a deployment based on the result of the process, particularly the benchmarks.

The deployment and/or upgrading of software on heterogenous devices with different computational capabilities can be complex, especially if they need to fulfil QOS requirements like timeliness (real-time applications). The devices and particularly nodes may vary in terms of computational power and/or architectural details (e.g., architecture, cache size and memory hierarchy and/or frequency and/or microarchitectural details like the pipeline depth) and/or other hardware and/or software features provided by the platform for resource control. Devices in such a system may range from powerful cloud and/or edge computation centres to smaller computation nodes with the performance of, e.g., a Raspberry Pi or even resource limited microcontrollers. Additionally specialized devices like GPU's, DSPs or FPUs may be provided. When dealing with such a diversity of devices, uninformed upgrades and/or deployment of software, particularly applications and/or application containers, can lead to either performance degradation or even incorrect application behaviour. In many cases, it is important for the orchestrator to select the right “algorithm quality” for a dedicated node considering the trade-offs between accuracy and computational efficiency, e.g., less accuracy with faster computation. In distributed setups, applications can interact which each other to realize a higher functionality. Ingress and egress network bandwidth to a list of other nodes in the system may be provided to realize reliable end-to-end latencies for a cause-effect chain including multiple functional components executed on different devices in the system, particularly distributed system. To efficiently utilize such a system and keep response times of an application within defined timing requirements this invention may provide a mechanism to automatically determine the capabilities, particularly computational and/or architectural and/or software capabilities, of devices in such a distributed system.

The present invention may allow to provide information about the overall computation capabilities of the hardware nodes, their current available resources (as e.g. remaining CPU capacity or memory capacity) before upgrading and/or deploying new applications. The central orchestrator may also be enabled to normalize the behaviour of different nodes, with different architectures, running at different frequencies, etc. Furthermore, the central orchestrator may also be enabled understand the features for resource isolation and reservation provided by the hardware to optimally upgrade and/or deploy applications.

According to an example embodiment of the present invention, it is possible that the devices are configured as nodes in a computing system, in particular an edge and/or cloud computing system and/or distributed system. Each of the nodes may be capable of executing the software, particularly an application and/or an application container. However, the capabilities of the devices for executing the software may differ from each other. Therefore, the process for determining the respective capability may be initiated as at least one benchmark and particularly multiple benchmarks for quantifying this difference.

Preferably, each node is capable of hosting a platform neutral byte-code format runtime like an interpreter and/or a compiler for executing the software in an intermediate byte code format. Therefore, the software may be written in the intermediate byte code format like WebAssembly. This allows to execute the software irrespective of the architecture of the node.

It is also possible that the decision is carried out to decide on the upgrade and/or deployment of the software on the at least one and particularly multiple connected device(s). The decision may be carried out based on the determined capability of the at least one connected device and further determined capabilities of (the) further of the (particularly also connected) devices to decide on which of the devices the software is upgraded and/or deployed. The process may comprise at least one benchmark that is initiated to run on the respective device. For example, if a request for upgrading and/or deploying a software is received, the process may be initiated multiple times to be executed on the multiple of the devices. Afterwards, the respective received results may be evaluated and/or compared with each other to find the most suitable device for the upgrade and/or deployment of the software according to the decision.

It is also possible that the process for determining the at least one capability determines at least one of the following capabilities of the at least one connected device:
a computational capability specific for a computing performance of the device,
a hardware capability comprising at least one specification on a hardware topology of the device,
an architecture capability comprising at least one specification on an architecture and/or microarchitecture of the device,
a performance capability specific for at least one performance related metric of the device,
a software capability specific for a software of the device, particularly a software version.

Each capability may influence the overall capability of the device to execute the software to be upgraded and/or deployed. Furthermore, each capability may be quantified using the process particularly in the form of one or multiple benchmarks.

It is also possible that the request comprises an application manifest that specifies the application requirements on the device for the execution of the software. The decision may therefore also be carried out based on this application manifest, particularly a comparison of the determined capability of the at least one connected device and the application manifest and/or of multiple of the connected devices with the application manifest. The application manifest may define the requirements for the execution of the software such as Quality of Service-requirements.

It is also possible that the process comprises at least one benchmark for testing the or each of the capabilities, particularly of each connected device. However, the process may not be carried out centrally but on each of the connected devices separately. The at least one benchmark and/or the software may therefore be provided to the device, for example transmitted to the devices via the connection. The at least one benchmark and/or the software may be provided based on an intermediate bytecode format, particularly WebAssembly.

For example, the at least one benchmark and/or the software may be provided by transmitting the at least one benchmark and/or the software from a central orchestrator to the device or each of the devices. Alternatively, or additionally, the at least one benchmark and/or the software may be provided by providing a location for downloading the at least one benchmark and/or software to the device or each of the devices. This allows the or each device to carry out the provided and particularly transmitted or downloaded at least one benchmark and/or software for determining the device's at least one capability. Particularly the central orchestrator is executed by a central data processing apparatus different from the device(s). It should also be highlighted that benchmarks may be used which are compiled to an intermediate bytecode format like WebAssembly which can be executed on any device with a supporting runtime, irrespective of the architecture.

According to an example embodiment of the present invention, the steps of initiating the process and receiving the result may be carried out for each of the multiple heterogenous devices by a central orchestrator for automatically quantifying the capabilities for executing the software by the devices and for an upgrade and/or deployment of the software on these devices. Therefore, another aspect of the present invention can be a central orchestrator for automatically quantifying the capabilities for executing the software by the multiple heterogenous devices of a computing system and an upgrade and/or a deployment of the software on these devices.

Another aspect of the present invention is a data processing apparatus comprising means for carrying out the method according to the present invention.

According to another aspect of the present invention, a device for a computing system may be provided. According to an example embodiment of the present invention, the device may comprise means for carrying out a process for determining its capability for executing a software upon an initiation by a central orchestrator of the computing system and for reporting back the results of the process to the central orchestrator. Furthermore, the process may comprise at least one or multiple benchmarks that are received as intermediate bytecode and/or source files and/or pre-compiled binaries by the device.

In another aspect of the present invention a computer program may be provided, in particular a computer program product, comprising instructions which, when the computer program is executed by a computer, cause the computer to carry out the method according to the present invention. Thus, the computer program according to the present invention can have the same advantages as have been described in detail with reference to a method according to the present invention.

The computer may be a data processing device which executes the computer program. The computer may include at least one processor that can be used to execute the computer program. Also, a non-volatile data memory may be provided in which the computer program may be stored and from which the computer program may be read by the processor for being carried out.

According to another aspect of the present invention a computer-readable storage medium may be provided which comprises the computer program according to the present invention. The storage medium may be formed as a data storage device such as a hard disk and/or a non-volatile memory and/or a memory card and/or a solid state drive. The storage medium may, for example, be integrated into the computer.

Furthermore, the method according to the present invention may be configured as a computer-implemented method.

Further advantages, features and details of the present invention will be apparent from the following description, in which example embodiments of the present invention are described in detail with reference to the figures. In this connection, the features mentioned in the description may each be essential to the present invention individually or in any combination.

### BRIEF DESCRIPTION OF THE DRAWINGS

FIG. 1 shows exemplarily embodiments of the present invention.

FIG. 2 shows an exemplarily system setup according to example embodiments of the present invention.

FIG. 3 shows an exemplarily capability discovery protocol according to example embodiments of the present invention.

In the following figures, the identical reference signs are used for the same technical features even of different embodiment examples.

### DETAILED DESCRIPTION OF EXAMPLE EMBODIMENTS

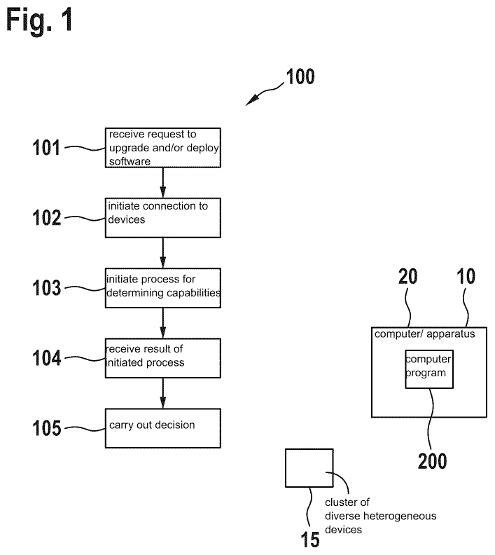

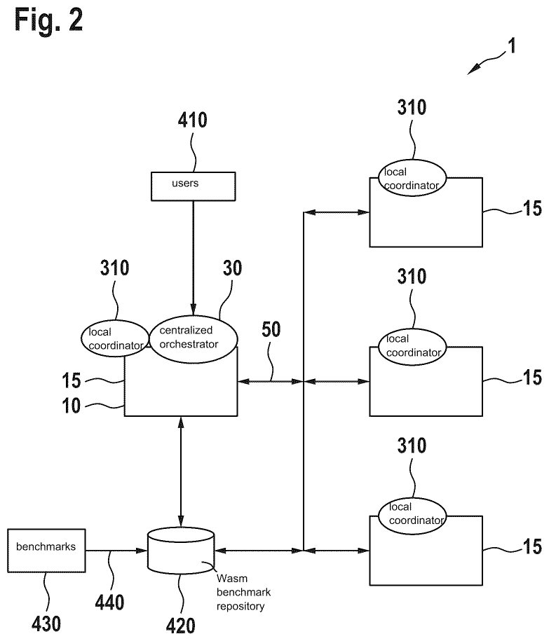

A method 100 according to embodiments of the present invention is schematically shown in FIG. 1. The method 100 may be used for upgrading and/or deploying software on multiple heterogenous devices 15, as schematically visualized in FIG. 2. According to a first method step 101, a request to upgrade and/or deploy software on at least one of the devices 15 is received. Then, according to a second method step 102, a connection 50 to the at least one of the devices 15 may be initiated. Afterwards, according to a third method step 103, a process for determining at least one capability of the at least one connected device 15 for executing the software may be initiated. The initiating 103 may be carried out via the connection 50. Then, according to a fourth method step 104, a result of the initiated process may be received, particularly via the connection 50. Then, according to a firth method step 105, a decision for the upgrade and/or deployment of the software based on the received result may be carried out.

Typically, computation systems like edge computing systems are characterized by a huge cluster of diverse heterogeneous devices 15, particularly nodes, ranging from microcontrollers, single board-computers to large servers, with diverse computing capabilities. Moreover, these devices 15 may enter and exit the edge system dynamically. The method 100 allows e.g. to automatically assess the capabilities of the device 15 and to automatically decide if and particularly which variant of the software to upgrade and/or deploy.

Also, a deployment and/or upgrade of software onto multiple devices 15 may be provided by the method 100, as in Content Delivery Networks where streaming software must be upgraded to end devices 15 which can be very heterogeneous.

Furthermore, a computer program 200, a device 15 and an apparatus 10 according to embodiments of the present invention is shown in FIG. 1.

Automatically assessing the capabilities of a node and deciding if and particularly which variant to deploy is not handled by current infrastructures/deployment systems like Kubernetes. These infrastructures are generally deployed in datacentre like environments consisting of large clusters of homogeneous nodes.

Therefore, the granularity of computation capabilities is often described in the number of CPUs and the size of the memory. Applications can be assigned to number CPUs and a portion of memory in the system. Also deciding on different implementation alternatives trading-off computation time vs. algorithmic accuracy depending on the available computation power is not handled by current existing frameworks. Additionally, there is a need for normalization. In a datacentre-like environment, all nodes may be homogenous (similar architecture and capabilities) and therefore a user can demand that he/she needs “X %” of compute power on Y-cores. But when the nodes are heterogeneous, 20% capacity on a single core microcontroller may be vastly different from 20% on a very powerful server with 32 cores. Hence there is a need for normalization across different nodes. The use of particularly benchmarks to determine the performance and using a normalization strategy may therefore be useful for efficient application deployment and resource usage accounting. However, there is a need for mechanisms that can deal with heterogeneous nodes and be able to provide uniform resource specification interfaces. Furthermore, a deeper understanding of the software and hardware capabilities of the target platform can help in more efficient application mapping.

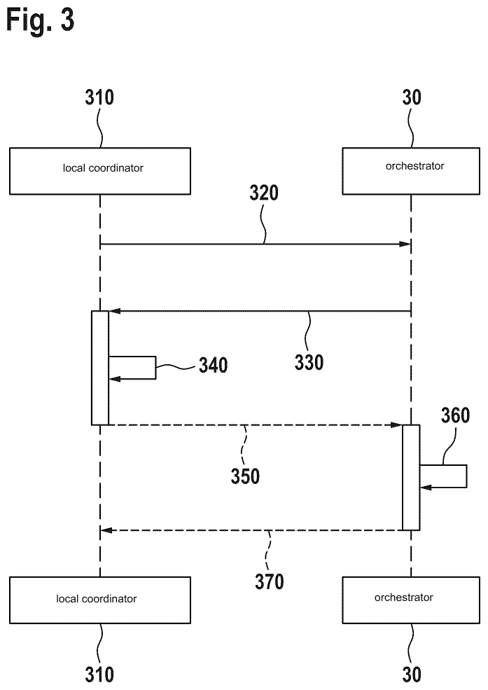

A core of embodiments of the present invention may be a mechanism that automatically quantifies the computational capabilities of a device and particularly a node in the system and maps the software to be upgraded and/or deployed on the device providing the right computation capabilities. In FIGS. 2 and 3, an exemplarily embodiment is shown where the devices 15 are nodes in a system 1 and a central orchestrator 30 is provided to carry out the method 100 at least partially. It can be possible that, whenever a new node registers with the central orchestrator 30, the orchestrator 30 may initiate the process for determining the at least one capability of the node by sending a set of benchmarks to the new node. These benchmarks may include programs to discover microarchitectural features (like cache size, layout, instructions per cycle, etc.) and the presence of other features (presence of performance monitors, partitioning capabilities, bus arbitration mechanisms), and other specialized compute capabilities (presence of GPU, FPU, etc.). The node may then execute these benchmarks and report the results, as a capability feature vector, back to the orchestrator 30. The orchestrator 30 may receive this result of the initiated process and may also normalize the results across different nodes and uses this normalized view of node capabilities to upgrading and/or deployment applications. This allows an efficient upgrading and/or deployment and migration of workloads in a network of distributed computation nodes.

The above-mentioned mechanism may be advantageous if a software, e.g. an algorithm, is given with different variants needing different levels of computational capabilities. Then, the orchestrator 30 may infer the capabilities of the node and upgrade and/or deploy the right variant to it. Also, this mechanism may be advantageous since the application requirements can be matched (e.g., app X needs to be deployed onto a device with a specific architecture and/or with hardware features like the ability to partition the cache). Depending on the execution environment (sufficient compute power to host compilers), it may also be decided according to the decision of the method 100 whether to upgrade and/or deploy the precompiled binary/ahead-of-time compiled version or another form (source code) to the node. This can be important since resource constrained nodes may not have enough memory or compute to host full-fledged compilation environments.

According to embodiments of the present invention, as shown in FIGS. 2 and 3, a centralized orchestrator 30 may be provided. The centralized orchestrator 30 may be configured as a software component which has a global knowledge of the system 1 and is responsible for carrying out a decision for upgrading and/or deploying software, e.g. applications, to different devices 15, e.g. nodes. These devices 15 may be heterogeneous as described earlier and dynamically register and de-register with the orchestrator 30. On each of the devices 15, another software component also referred to as the local coordinator 310 may be provided which may communicate to the orchestrator 30 via a publish subscribe mechanism like MQTT/DDS or simply in a client-server manner, according to the connection 50. The local coordinator 310 may periodically send back information regarding the current resource availability on each of the devices 15 to the orchestrator 30.

Users 410 may further send their request to upgrade and/or deploy their application with an application manifest to the centralized orchestrator 30. The application manifest may specify the application requirements on the target device 15, particularly node. The application manifest may comprise specifications according to at least one of the following:
the kind of architecture, like x86 or arm64,
the type of processor, like microcontroller or microprocessor,
the presence of specialized processing units, like GPU, FPGA,
the application QOS requirements, like best effort, timing critical, soft real-time,
the application network bandwidth requirements,
the application variants, like low accuracy, high accuracy,
the parallelism features of the application and preference to hardware offering parallelism capabilities,
the application topology like constituent modules and their interactions via messages.

A new device 15 may become part of the distributed system 1 when the local coordinator 310 registers with the orchestrator 30. The orchestrator 30 may then initiate the process according to the method 100 by sending it a set of benchmarks 430 to derive the device's capabilities. These benchmarks 430 may be sent either as source files or pre-compiled binaries. The orchestrator 30 may also send a location of the benchmark storage so that they could be also pulled (downloaded) from a benchmark registry by the local coordinator 310. These (micro) benchmarks 430 may be designed to discover different aspects of the device 15, for example at least one of the following:
Basic features to understand the hardware topology of the device 15, like architecture, frequency, memory, number of cores, memory layout including cache sizes, processor type (microcontroller, microprocessor), network bandwidth.
Microarchitectural details, like pipeline depth, presence of superscalar pipelines, in-order or out of order execution, hyperthreading support, availability of a memory management unit or memory protection unit.
Performance related metrics, like floating point performance, instructions-per-cycle (IPC).
Stress benchmarks, like benchmarks that can stress the memory to determine the maximum bandwidth and even a detection of interference sensitivity can be achieved by executing memory intensive applications on different cores. Similar methods can be used to determine performance figures of hardware accelerators.
Bandwidth capacities from the new node to all existing nodes can be measured by dedicated applications. Also, performance improvements may be achieved due to superscalar pipelines be extracted by constructing the benchmarks in a way to explore this parallelism.
Hardware Resource Regulation features, like benchmarks to discover what hardware features the platform offers: presence of performance monitoring counters, ability to partition the cache, specialized regulation mechanisms like ARM MPAM, support for network bandwidth reservations, hardware time synchronization support.
Basic Software Capabilities, like a type of OS, availability of compilers, hypervisors.
Software Resource Regulation Mechanisms, like a presence of reservation-based schedulers, memory bandwidth regulation mechanisms like Memguard, cache colouring support in the operating system.

The local coordinator 310 of the new device 15 may execute the benchmarks 430 and possible (interference) scenarios and reports back the results of the benchmarks 430 to the central orchestrator 30 (also referred to as central coordinator) as a capability feature vector. The central coordinator 30 may then normalize these values for all platforms in the system 1 to generate a list of performance features and comparable performance values across the devices 15, particularly hardware nodes (see FIG. 3, which shows an exemplarily capability discovery protocol between the local coordinator and the orchestrator 30). This information is then used to coordinate the (dynamic) software upgrade and/or deployment in this environment.

In FIG. 3, the exemplarily capability discovery protocol may provide a communication between a local coordinator 310, executed by a local device 15, and an orchestrator 30 via a connection 50 (latter shown in FIG. 2). First, a node registration request 320 may be send from the local coordinator 310 to the orchestrator 30. Then, the orchestrator 30 may send benchmarks for execution (see 330). Afterwards, the local coordinator 310 may execute 340 the benchmarks in order to determine the capabilities of the local device 15. Then, the local coordinator 310 may return a capability feature vector 350 to the orchestrator 30. The orchestrator 30 may then derive a normalized node profile 360 from the received capability feature vector 350. Depending on the decision according to a method 100, the node may be registered 370.

With the information regarding the software and hardware capabilities of each registered device 15, whenever a user 410 request to upgrade and/or deploy certain application is made the orchestrator 30 then can make intelligent decisions regarding where the application may be upgraded and/or deployed. Some selection criteria may combine one or more heuristics. If the application has specific requirements on the architecture and specialized processing requirements, the orchestrator 30 may select the matching devices 15 and upgrades and/or deploys the application onto it. If the application has real-time requirements with specific resource reservations, then the orchestrator 30 may match it with a device 15 providing hardware and software resource reservation capabilities. The local coordinator 310 may guarantee a new application a fixed portion of one or multiple cores and a guaranteed memory bandwidth/cache lines to protect against interference. With the performance estimation of the platform and a guaranteed CPU share, a central coordinator 30 can decide, if an application with QoS demands (safety/real-time critical) can be upgraded and/or deployed on which device 15 and which functional quality can be fulfilled. If the application has multiple versions (low accuracy, high accuracy) needing different device capabilities and the application needs to be upgraded and/or deployed or installed on all the devices 15, the orchestrator 30 may upgrade and/or deploy the right version on the devices 15 matching its capabilities. If the application must be upgraded and/or deployed on all devices 15 with varying capabilities of the execution environment, the orchestrator 30 may either decide to pre-compile the application for the specific target if it does not have enough resources to host a compiler, or send the source code if the target device 15 has a compiler and sufficient compute 20 and memory resources, or send an intermediate representation (WebAssembly byte code compiled version) when it has a bytecode execution runtime. Since the orchestrator 30 may have a normalized view of the device capabilities, it can also carry out efficient decisions to balance the load or optimize network usage across different devices 15.

For an execution of benchmarks 430 on the target device 15, every device 15 that needs to register may have a software component called the local coordinator 310 which talks to the orchestrator 30. This local coordinator 310 may host a runtime environment capable of compiling either source code to target or intermediate byte code formats (like WebAssembly) to the target machine code. The interesting property of WebAssembly (and other bytecode runtimes) is that it is architecture and language independent. With this, as seen in FIG. 2, which shows an exemplarily system setup, the orchestrator 30 may compile benchmarks 430 from different languages to the common bytecode format and upgrade and/or deploy it to the local coordinator 310. Irrespective of the architecture and presence of language specific compilers, the coordinator may execute these benchmarks 430 and sends the results back to the orchestrator 30 over the pub-sub communication interface.

In FIG. 2, it is shown that multiple devices 15 may be connected to each other in an exemplarily setup of a system 1, for example a system for providing edge computing. A user 410 may transmit an app upgrading and/or deployment request together with an application manifest to the orchestrator 30. The orchestrator 30 as well as the local coordinators 310 may be executed by devices 15, each providing a computation node 10, 15. One of the computation nodes 10, 15 may centrally provide the orchestrator and each of the computation nodes 10, 15 may provide a local coordinator 30. Furthermore, it is shown that different benchmarks 430, particularly in different languages, may be provided using a WebAssembly compiler 440 and a Wasm Benchmark Repository 420.

Embodiments according to the present invention may be used for a dynamic distribution of workloads in a software defined factory or software-defined vehicle. For example, embodiments of the present invention may be used in infrastructure based automated driving where vehicles do not have the full hardware equipment in the car, which may be relying on external computation devices (within controlled areas like factory plants or in cities). Also, embodiments according to the present invention may be used in edge orchestration engines and/or content delivery networks where software must be upgraded to end devices 15 which can be very heterogeneous.

The foregoing explanation of the embodiments describes the present invention in the context of examples. Of course, individual features of the embodiments can be freely combined with each other, provided that this is technically reasonable, without leaving the scope of the present invention.

What is claimed is:

1. A method for carrying out a decision for upgrading and/or deploying software on multiple heterogenous devices, the method comprising the following steps:
receiving a request to upgrade and/or deploy software on at least one of the devices;
initiating a connection to the at least one of the devices;
initiating a process for determining at least one respective capability of the at least one connected device for executing the software, the initiating being carried out via the connection, the process being initiated for being executed by the at least one connected device;
receiving a result of the initiated process,
carrying out the decision for the upgrading and/or deployment of the software based on the received result.

2. The method of claim 1, wherein the devices are configured as nodes in an edge or cloud computing system, each of the nodes being capable of executing the software, the software including application and/or an application container, capabilities of the devices for executing the software differing from each other, and the process for determining the respective capability being initiated as at least one benchmark for quantifying the difference, and each of the nodes being capable of hosting a platform neutral byte-code format runtime for executing the software in an intermediate byte code format.

3. The method of claim 1, wherein the decision is carried out to decide on the upgrade and/or deployment of the software on the at least one connected device, the decision being carried out based on the determined capability of the at least one connected device and further determined capabilities of further of the devices to decide on which of the devices the software is upgraded and/or deployed.

4. The method of claim 1, wherein the process for determining the at least one capability determines at least one of the following capabilities of the at least one connected device:
a computational capability specific for a computing performance of the connected device,
a hardware capability including at least one specification on a hardware topology of the connected device,
an architecture capability including at least one specification on an architecture and/or microarchitecture of the connected device,
a performance capability specific for at least one performance related metric of the connected device,
a software capability specific for a software of the connected device, including for a software version.

5. The method of claim 1, wherein the request includes an application manifest that specifies application requirements on the connected device for execution of the software, the decision being carried out based on a comparison of the determined capability of the at least one connected device and the application manifest.

6. The method of claim 1, wherein the process includes at least one benchmark for testing the capability, wherein the at least one benchmark and/or the software being provided to the connected device based on an intermediate bytecode format, wherein the at least one benchmark and/or the software is provided: (i) by transmitting the at least one benchmark and/or the software from a central orchestrator to the device, and/or (ii) by providing a location for downloading the at least one benchmark and/or the software to the device, so that the device carries out the transmitted or downloaded at least one benchmark and/or software for determining the at least one capability of the device, wherein the central orchestrator is executed by a central data processing apparatus different from the connected device.

7. The method of claim 6, wherein the intermediate bytecode formal is WebAssembly.

8. The method of claim 1, wherein steps of initiating the process and receiving the result are carried out for each of the multiple heterogenous devices by a central orchestrator for automatically quantifying the capabilities for executing the software by the devices and for an upgrade and/or deployment of the software on the devices.

9. A data processing apparatus configured to carry out a decision for upgrading and/or deploying software on multiple heterogenous devices, the data processing apparatus configured to:
receive a request to upgrade and/or deploy software on at least one of the devices;
initiate a connection to the at least one of the devices;
initiate a process for determining at least one respective capability of the at least one connected device for executing the software, the initiating being carried out via the connection, the process being initiated for being executed by the at least one connected device;
receive a result of the initiated process,
carry out the decision for the upgrading and/or deployment of the software based on the received result.

10. A device for a computing system, the device configured to carry out a process for determining a capability of the device for executing a software upon an initiation by a central orchestrator of the computing system, and to report back results of the process to the central orchestrator, the process including benchmarks that are received by the device as intermediate bytecode and/or source files and/or pre-compiled binaries.

11. A non-transitory computer-readable medium on which is stored a computer program including instructions for carrying out a decision for upgrading and/or deploying software on multiple heterogenous devices, the instructions, when executed by a computer, causing the computer to perform the following steps:
receiving a request to upgrade and/or deploy software on at least one of the devices;
initiating a connection to the at least one of the devices;
initiating a process for determining at least one respective capability of the at least one connected device for executing the software, the initiating being carried out via the connection, the process being initiated for being executed by the at least one connected device;
receiving a result of the initiated process,
carrying out the decision for the upgrading and/or deployment of the software based on the received result.
